(19) United States
(12) Patent Application Publication
(10) Pub. No.: US 2022/0288716 A1
(43) Pub. Date: Sep. 15, 2022

(54) FLEXIBLE WELDING GUN TUBE

(71) Applicant: Lincoln Global, Inc., Santa Fe Springs, CA (US)

(72) Inventor: Rahul R. Bhakta, Mentor, OH (US)

(21) Appl. No.: 17/198,407

(22) Filed: Mar. 11, 2021

(51) Int. Cl. B23K 9/32; B23K 9/12

(52) U.S. Cl. CPC B23K 9/32; B23K 9/122

(57) ABSTRACT

A flexible conductive gun tube has a plurality of articulated segments connected in series for conducting welding current from a torch handle to a diffuser. Each of the articulated segments has an outer housing having a radially inwardly projecting rim at a first end, and an internal annular groove proximate a second end. A first attachment member includes a ball portion and a first attachment projection that extends away from ball portion and is attached to a first adjacent segment of the gun tube. A second attachment member includes a socket and a second attachment projection that extends axially from the socket past the internal annular groove. The second attachment projection is attached to a second adjacent segment of the gun tube. A retaining ring is located within the internal annular groove, and a biasing member is located axially between the retaining ring and the socket.

### BACKGROUND OF THE INVENTION

### Field of the Invention

The present invention relates to welding guns, and in particular to gun tubes for driven wire electrode arc welding, such as gas metal arc welding (GMAW), flux-cored arc welding (FCAW) and metal-cored arc welding (MCAW).

### Description of Related Art

Gun tubes for welding guns can be straight or bent but are not typically flexible. In conventional welding guns, the angle of the gun tube with respect to the gun's handle is fixed. Thus, the entire gun must be repositioned as a welding direction or angle changes. Different welding operators may prefer different approach angles when welding. One operator may prefer to hold the handle of the welding gun generally parallel to the workpieces, which might require a sharp bend in the gun tube, while another operator may prefer to weld with the gun tube generally straight. It would be desirable to provide a welding gun having a flexible gun tube so that the orientation of the distal end of the gun, at the nozzle end, with respect to the handle can be adjusted to accommodate various welding directions and operator preferences.

### BRIEF SUMMARY OF THE INVENTION

The following summary presents a simplified summary in order to provide a basic understanding of some aspects of the devices, systems and/or methods discussed herein. This summary is not an extensive overview of the devices, systems and/or methods discussed herein. It is not intended to identify critical elements or to delineate the scope of such devices, systems and/or methods. Its sole purpose is to present some concepts in a simplified form as a prelude to the more detailed description that is presented later.

In accordance with one aspect of the present invention, provided is a flexible conductive gun tube for a welding torch. The flexible conductive gun tube comprises a plurality of articulated segments connected in series for conducting welding current from a torch handle to a torch diffuser. An articulated segment of the plurality of articulated segments comprises an outer housing having an axially-extending body, and a radially inwardly projecting rim located at a first end of the axially-extending body and defining an opening into an interior of the outer housing. The axially-extending body has an internal annular groove formed in an inner surface of the axially-extending body, and the internal annular groove is located proximate a second end of the axially-extending body opposite the first end. Each of the articulated segments further includes a first attachment member for attachment to a first adjacent articulated segment of the plurality of articulated segments, wherein the first attachment member comprises a ball portion located within the outer housing and that extends through said opening, and a first attachment projection that extends away from ball portion and the outer housing and is attached to the first adjacent articulated segment. Each of the articulated segments further includes a second attachment member for attachment to a second adjacent articulated segment of the plurality of articulated segments, wherein the second attachment member comprises a socket located within the outer housing for receiving the ball portion, and a second attachment projection integrally formed with the socket and extending axially from the socket past the internal annular groove, wherein the second attachment projection is attached to the second adjacent articulated segment. A retaining ring is located within the internal annular groove, and a biasing member is located within the outer housing, radially between the second attachment projection and the axially-extending body, and axially between the retaining ring and the socket.

In accordance with another aspect of the present invention, provided is a flexible conductive gun tube for a welding torch. The flexible conductive gun tube comprises a plurality of articulated segments connected in series for conducting welding current from a torch handle to a torch diffuser. An articulated segment of the plurality of articulated segments comprises an outer housing having an axially-extending body, and an annular projection located radially inward of an inner surface of the axially-extending body. The axially-extending body has an internal annular groove formed in the inner surface and located proximate an end of the axially-extending body opposite the annular projection. Each of the articulated segments further includes a first attachment member for attachment to a first adjacent articulated segment of the plurality of articulated segments, wherein the first attachment member comprises a ball portion located within the outer housing, and a first attachment projection that extends away from ball portion and the outer housing and is attached to the first adjacent articulated segment, wherein an axial movement of the ball portion within the outer housing is limited by the annular projection. Each of the articulated segments further includes a second attachment member for attachment to a second adjacent articulated segment of the plurality of articulated segments, wherein the second attachment member comprises a socket located within the outer housing for receiving the ball portion, and a second attachment projection extending axially from the socket past the internal annular groove, wherein the second attachment projection is attached to the second adjacent articulated segment. A retaining ring is located within the internal annular groove and radially between the second attachment projection and the internal annular groove. A spring is located within the outer housing, radially between the second attachment projection and the axially-extending body, and axially between the retaining ring and the socket, wherein the spring biases the second attachment member toward the ball portion.

In accordance with another aspect of the present invention, provided is a flexible conductive gun tube for a welding torch. The flexible conductive gun tube comprises a plurality of articulated segments connected in series for conducting welding current from a torch handle to a torch diffuser. An articulated segment of the plurality of articulated segments comprises an outer housing having an axially-extending body forming a cylindrical outer surface, and a radially inwardly projecting rim located at a first end of the axially-extending body and defining an opening into an interior of the outer housing. The axially-extending body has an internal annular groove formed in an inner surface of the axially-extending body, and the internal annular groove is located proximate a second end of the axially-extending body opposite the first end. Each of the articulated segments further includes a first attachment member for attachment to a first adjacent articulated segment of the plurality of articulated segments, wherein the first attachment member comprises a ball portion located within the outer housing and that extends through said opening, and a first attachment projection that extends away from ball portion and the outer housing and that has internal threads for connecting the first attachment member to the first adjacent articulated segment. Each of the articulated segments further includes a second attachment member for attachment to a second adjacent articulated segment of the plurality of articulated segments, wherein the second attachment member comprises a socket located within the outer housing for receiving the ball portion, and a second attachment projection integrally formed with the socket and extending axially from the socket past the internal annular groove, wherein the second attachment projection has external threads for connecting the second attachment member to the second adjacent articulated segment. A retaining ring is located within the internal annular groove and radially between the second attachment projection and the internal annular groove. A spring is located within the outer housing, radially between the second attachment projection and the axially-extending body, and axially between the retaining ring and the socket, wherein the spring biases the second attachment member toward the ball portion.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 shows a welding gun;

FIG. 2 shows a welding gun tube;

FIG. 3 shows the welding gun tube;

FIG. 4 shows the welding gun tube;

FIG. 5 shows a cross-section of the welding gun tube;

FIG. 6 is a perspective view of a segment of the welding gun tube;

FIG. 7 is a perspective view of a segment of the welding gun tube;

FIG. 8 shows a further welding gun tube; and

FIG. 9 shows a cross-section of the further welding gun tube.

### DETAILED DESCRIPTION OF THE INVENTION

The present invention relates to welding guns, and in particular to gun tubes for welding guns. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

Embodiments of the present invention are described herein in the context of an arc welding gun. In addition to welding operations, embodiments of the present invention can be used in additive manufacturing processes and other welding-type processes, such as hardfacing. Thus, the term “welding” is to be interpreted to include such welding-type processes.

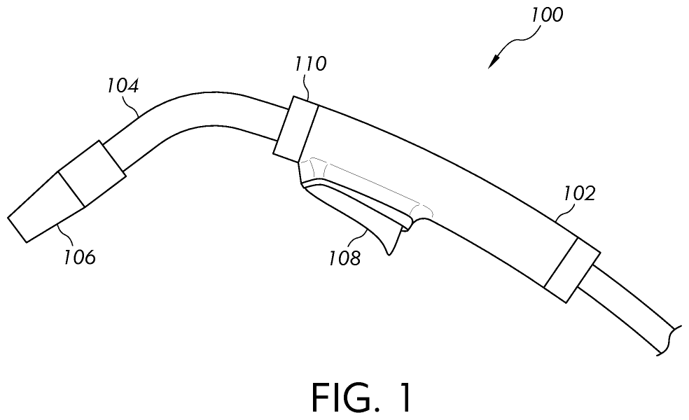

FIG. 1 shows the distal end of a welding gun 100. The welding gun 100 would include a cable and power pin (not shown) at its proximal end for connection to a welding machine or wire feeder. Electrical current for arc welding, and a shielding gas, flow through the cable to the gun handle 102 and gun tube 104. The shielding gas is directed toward the weld zone by a nozzle 106 on the welding gun 100. A welding operation is started and stopped via a trigger 108 on the welding gun 100. The welding gun 100 includes an attachment mechanism, such as a threaded collar 110, for attaching and detaching the gun tube 104 from the gun handle 102.

The gun tube 104 is flexible so that the angle of the gun tube can be varied from straight to bent, as shown in FIG. 1. The gun tube 104 comprises a plurality of articulated segments connected together in series, and the orientation of adjacent articulated segments can be adjusted change the overall axial shape of the gun tube. The gun tube 104 and its articulated segments can be covered by a flexible, electrically insulating material, such as a rubber material. The flexible covering for the gun tube 104 is shown in FIG. 1, but is omitted in the remaining figures to illustrate the articulated segments forming the gun tube. The flexible covering can be attached to the gun tube 104 at the opposite ends of the gun tube, such as via a crimp, clamp or other appropriate means of attachment.

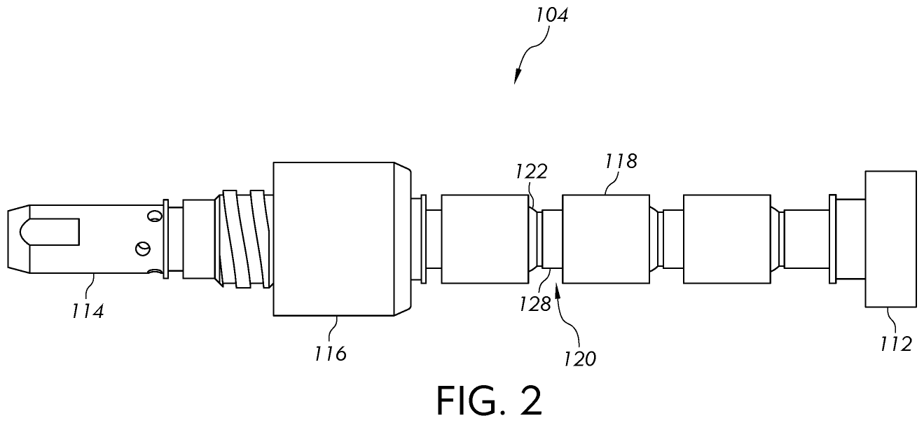

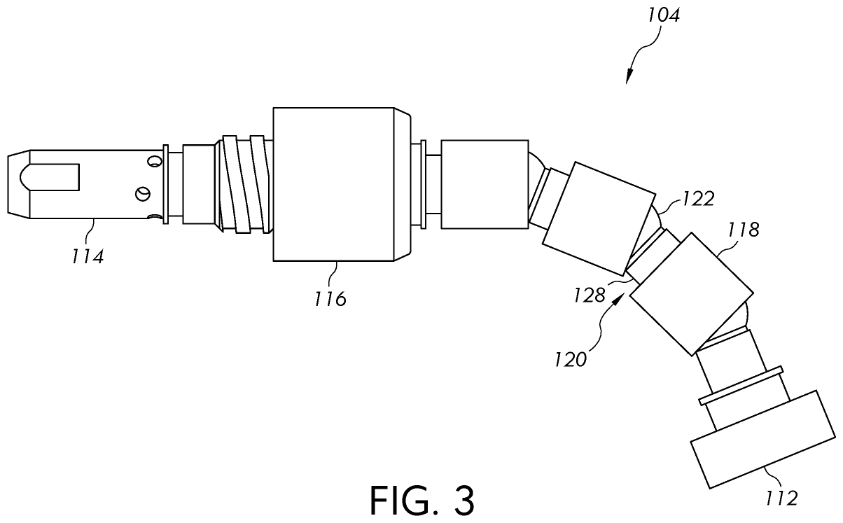

FIG. 2 shows an example flexible conductive gun tube 104 with three articulated segments. It is to be appreciated that the gun tube 104 can include fewer or more than three articulated segments, and could include as many articulated segments as desired. The gun tube 104 is shown straight in FIG. 2 and shown bent in FIG. 3. The proximal end of the gun tube 104 has a gun tube base 112 for connecting the gun tube to the handle 102 of the torch. The gun tube base 112 is electrically conductive and has a central bore to convey welding current and shielding gas into the gun tube 104. The distal end of the gun tube 104 is connected to a gas diffuser 114. The gun tube 104 can include an adapter covered by an insulator 116 onto which the diffuser 114 is threaded.

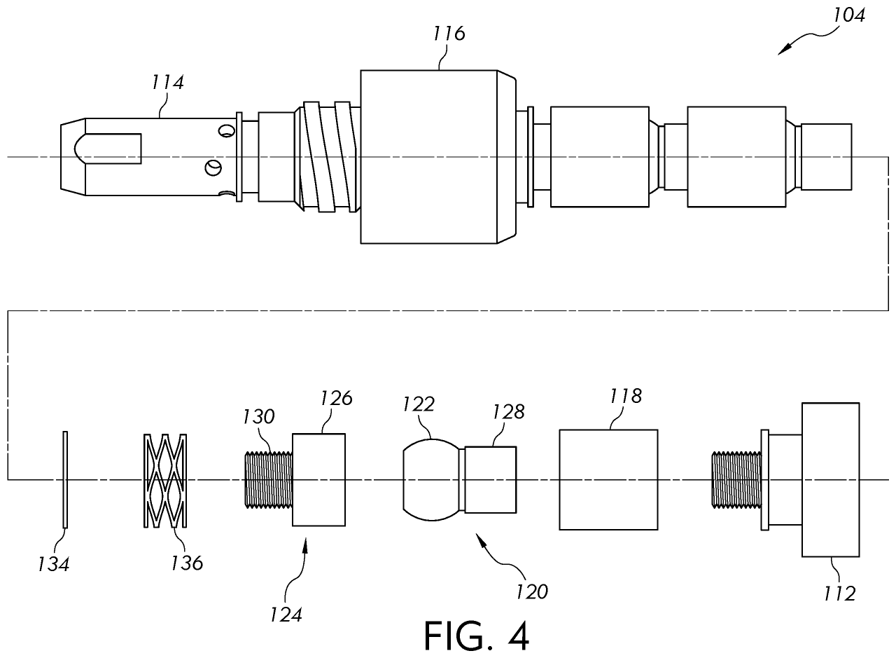

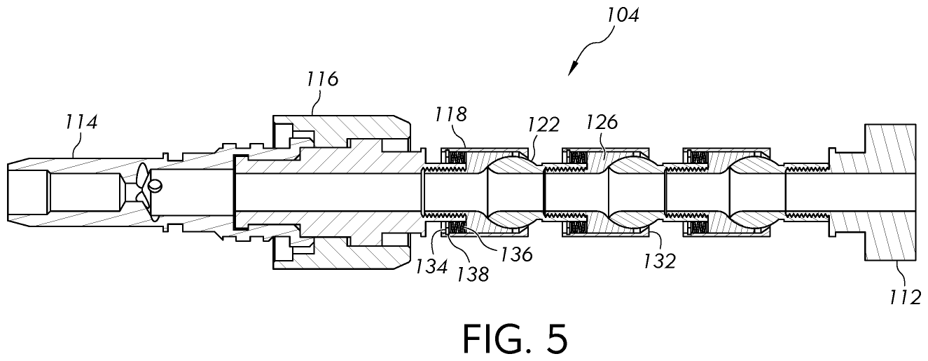

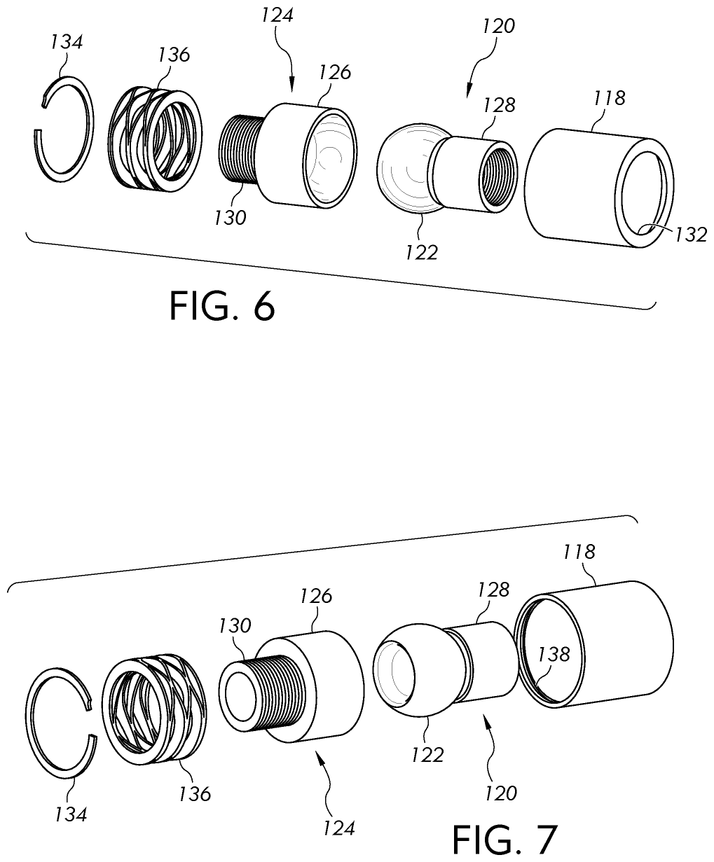

The articulated segments forming the gun tube 104 have a ball and socket design that allow the gun tube to be bent into a desired shape. FIG. 4 shows the gun tube 104 with one of the articulated segments displayed in an exploded view. FIG. 5 shows the gun tube 104 in cross section, and FIGS. 6 and 7 provide perspective exploded views of an articulated segment of the gun tube. The articulated segments will now be described with reference to FIGS. 2-7.

The articulated segments include an outer housing 118 that holds a first attachment member 120 having a ball portion or ball head 122, and a second attachment member 124 having a socket 126 within the outer housing that receives the ball head. The ball head 122 and socket 126 form a ball-and-socket joint that allows rotation of the first attachment member 120 of each articulated segment, which gives flexibility to the gun tube 104. In the embodiments shown in the figures, the outer housing 118 has an axially-extending body with a cylindrical outer surface. However, the outer housing 118 could have other shapes if desired, such as a polygonal or spheroid shape.

The first attachment member 120 has a first attachment projection 128 that extends away from the ball head 122 and outer housing 118 in a proximal direction (e.g., toward the torch handle). The second attachment member 124 has a second attachment projection 130 that extends away from the socket 126 and outer housing 118 in a distal direction (e.g., toward the diffuser 114). The first attachment projection 128 can be integrally formed with the ball head 122 and the second attachment projection 130 can be integrally formed with the socket 126. The first attachment member 120 and the second attachment member 124 are formed form an electrically conductive material, such as copper, to conduct welding current from a welding machine through the torch to a contact tip (not shown) attached to the diffuser 114. The first attachment member 120 of each articulated segment is connected to the second attachment member 124 of an adjacent (e.g., proximal) articulated segment or to the gun tube base 112. The second attachment member 124 of each articulated segment is connected to the first attachment member 120 of another adjacent (e.g., distal) articulated segment or to the adapter for the gas diffuser 114. The first attachment member 120 and the second attachment member 124 of an articulated segment each have a bore in fluid communication with each other for conveying shielding gas through the gun tube 104 to the diffuser 114. The bores are best shown in FIG. 5. The articulated ball-and-socket segments of the gun tube 104 can convey welding current and shielding gas from the torch handle to the diffuser 114 while imparting flexibility to the gun tube.

In the embodiment of FIGS. 2-7, the first attachment projection 128 of the first attachment member 120 is generally cylindrical and has internal threads for connecting to an adjacent articulated segment. However, the first attachment projection 128 could have external threads or another attachment mechanism if desired. The second attachment projection 130 is also shown as being generally cylindrical and has external threads for connecting to an adjacent articulated segment. However, the second attachment projection 130 could have internal threads or another attachment mechanism if desired. Moreover, the first attachment projection 128 and the second attachment projection 130 could have shapes other than cylindrical. For example, the first attachment projection 128 and the second attachment projection 130 could have corresponding polygonal shapes.

It is to be appreciated that the first attachment member 120 is movable within the outer housing 118 to adjust an angle between the first attachment projection 128 and the second attachment projection 130 within an articulated segment of the gun tube 104. The angle between the axis of the axially-extending body of the outer housing 118 and the second attachment projection 130 is generally fixed. However, because the first attachment member 120 is movable (e.g., pivotable) within the outer housing 118 via the ball-and-socket joint, the angle between the first attachment projection 128 and the second attachment projection 130 is variable within the articulated segment. Thus, the angle between the first attachment projection 128 and the second attachment projection 130 of each articulated segment is individually adjustable.

The outer housing 118 has an annular projection or radially inwardly projecting rim 132 that interferes with a proximal portion of the ball head 122 of the first attachment member 120, to limit or restrict the axial movement of the first attachment member within the outer housing. The annular projection 132 can be located at or proximate a first end of the outer housing 118, such as at a proximal end of the outer housing, and can project radially inward from an inner and/or outer surface of the body of the housing. The axially-extending body of the outer housing 118 can be formed as an open cylinder, and the annular projection 132 can be attached to or integrally formed with an inner surface of the open cylinder. In certain embodiments, the annular projection 132 is formed as a rim located at a terminal end of the axially-extending body of the outer housing 118. In other embodiments, the annular projection 132 is located axially inward of the terminal end of the axially-extending body of the outer housing 118.

The annular projection 132, when formed as a rim located at a terminal end of the axially-extending body of the outer housing 118, can define an opening into the interior of the outer housing. The majority of the ball head 122 of the first attachment member 120 is located within the outer housing 118. However, part of the ball head 122 can extend through the opening established by the annular projection 132. The annular projection 132 can include a contoured surface, such as a curved or beveled surface, that contacts the curved ball head 122.

To keep the ball-and-socket joint in place within the outer housing 118, the articulated segments include a biasing member that biases the socket 126 toward the ball head 122, and a retaining ring 134 that holds the biasing member in place within the outer housing. The biasing member can be one or more springs 136 under compression between the socket 126 and the retaining ring 134. Example springs 136 include wave springs, coil springs, and one or more wave washers. The inner surface of the axially-extending body forming the outer housing 118 has an internal annular groove 138 that holds the retaining ring 134. The annular groove 138 is located proximate a terminal end of the outer housing 118, opposite the end having the annular projection 132. The distal end of the socket 126, where it attaches to the second attachment projection 130, forms a shoulder with respect to the second attachment projection. The shoulder provides a radially-extending surface which receives a force from the spring 136 in the proximal axial direction that pushes the socket 126 onto the ball head 122. The ball head 122 is thus captured between the socket 126 and the annular projection 132 of the outer housing 118. The second attachment projection 130 extends distally past the annular groove 138 and out of the outer housing 118. The retaining ring 134 is located radially between the second attachment projection 130 and the annular groove 138, and axially between the distal terminal end of the outer housing 118 and the spring 136. The spring 136 is located radially between the second attachment projection 130 and the inner surface of the axially-extending body of the outer housing 118, and axially between the retaining ring 134 and the socket 126 (i.e., axially between the retaining ring and the shoulder formed by the socket/second attachment projection interface).

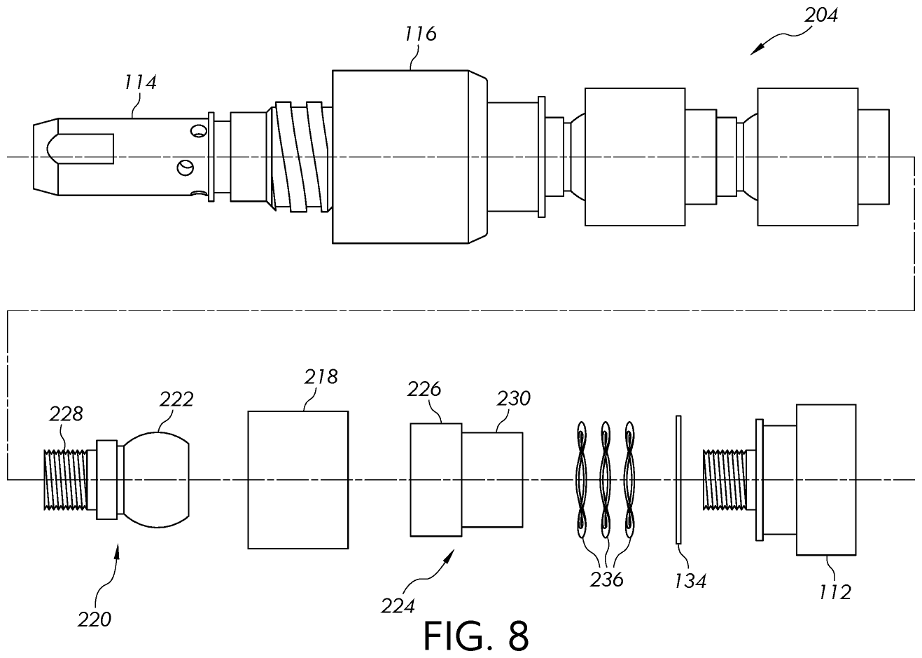

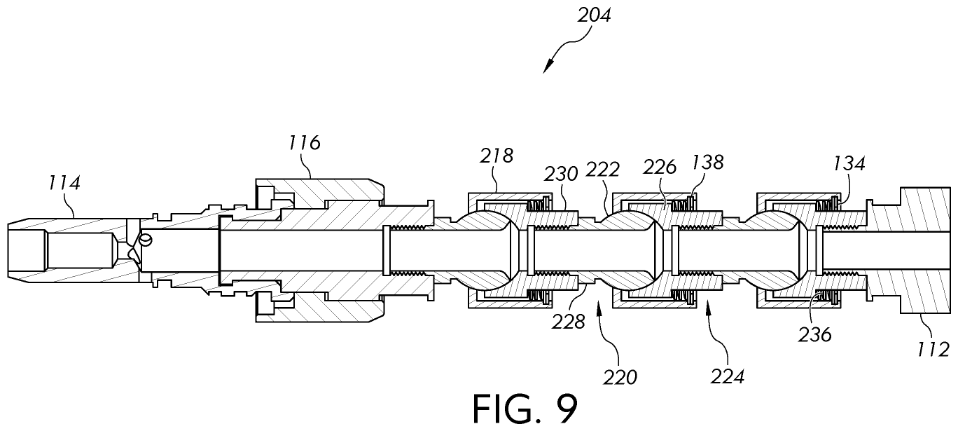

Turning to FIGS. 8 and 9, these figures show an embodiment of a welding gun tube 204 that is similar to the embodiment discussed above. However, the first attachment member 220 having the ball head 222 is located at the distal or downstream side of the outer housing 218, and the second attachment member 224 having the socket 226 is located at the proximal or upstream side of the outer housing. The first attachment projection 228 extends distally away from the ball head 222 and outer housing 218, and the second attachment projection 230 extends proximally away from the socket 226 and the outer housing. Moreover, the first attachment projection 228 has external threads for connecting to a distal adjacent articulated segment, and the second attachment projection 230 has internal threads for connecting to a proximal adjacent articulated segment. The bias member in the embodiment of FIGS. 8 and 9 includes a plurality of wave washers 236, but could include one or more wave springs as shown above in FIGS. 4, 6 and 7.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A flexible conductive gun tube for a welding torch, comprising:
a plurality of articulated segments connected in series for conducting welding current from a torch handle to a torch diffuser, wherein an articulated segment of the plurality of articulated segments comprises:
an outer housing having:
an axially-extending body; and
a radially inwardly projecting rim located at a first end of the axially-extending body and defining an opening into an interior of the outer housing,
wherein the axially-extending body has an internal annular groove formed in an inner surface of the axially-extending body, and the internal annular groove is located proximate a second end of the axially-extending body opposite the first end;
a first attachment member for attachment to a first adjacent articulated segment of the plurality of articulated segments, wherein the first attachment member comprises a ball portion located within the outer housing and that extends through said opening, and a first attachment projection that extends away from ball portion and the outer housing and is attached to the first adjacent articulated segment;
a second attachment member for attachment to a second adjacent articulated segment of the plurality of articulated segments, wherein the second attachment member comprises a socket located within the outer housing for receiving the ball portion, and a second attachment projection integrally formed with the socket and extending axially from the socket past the internal annular groove, wherein the second attachment projection is attached to the second adjacent articulated segment;
a retaining ring located within the internal annular groove; and
a biasing member located within the outer housing, radially between the second attachment projection and the axially-extending body, and axially between the retaining ring and the socket.

2. The flexible conductive gun tube of claim 1, wherein an axial movement of the ball portion within the outer housing is limited by the radially inwardly projecting rim.

3. The flexible conductive gun tube of claim 2, wherein the first attachment member is movable within the outer housing to adjust an angle between the first attachment projection and the second attachment projection.

4. The flexible conductive gun tube of claim 1, wherein the biasing member comprises a wave washer.

5. The flexible conductive gun tube of claim 1, wherein the biasing member comprises a plurality of wave washers.

6. The flexible conductive gun tube of claim 1, wherein the biasing member comprises a wave spring.

7. The flexible conductive gun tube of claim 1, wherein one of the first attachment projection and the second attachment projection has internal threads and a different one of the first attachment projection and the second attachment projection has external threads.

8. The flexible conductive gun tube of claim 1, wherein the first attachment projection has internal threads for connecting the first attachment member to the first adjacent articulated segment, and the second attachment projection has external threads for connecting the second attachment member to the second adjacent articulated segment.

9. A flexible conductive gun tube for a welding torch, comprising:
a plurality of articulated segments connected in series for conducting welding current from a torch handle to a torch diffuser, wherein an articulated segment of the plurality of articulated segments comprises:
an outer housing having:
an axially-extending body; and
an annular projection located radially inward of an inner surface of the axially-extending body,
wherein the axially-extending body has an internal annular groove formed in the inner surface and located proximate an end of the axially-extending body opposite the annular projection;
a first attachment member for attachment to a first adjacent articulated segment of the plurality of articulated segments, wherein the first attachment member comprises a ball portion located within the outer housing, and a first attachment projection that extends away from ball portion and the outer housing and is attached to the first adjacent articulated segment, wherein an axial movement of the ball portion within the outer housing is limited by the annular projection;
a second attachment member for attachment to a second adjacent articulated segment of the plurality of articulated segments, wherein the second attachment member comprises a socket located within the outer housing for receiving the ball portion, and a second attachment projection extending axially from the socket past the internal annular groove, wherein the second attachment projection is attached to the second adjacent articulated segment;
a retaining ring located within the internal annular groove and radially between the second attachment projection and the internal annular groove; and
a spring located within the outer housing, radially between the second attachment projection and the axially-extending body, and axially between the retaining ring and the socket, wherein the spring biases the second attachment member toward the ball portion.

10. The flexible conductive gun tube of claim 9, wherein the first attachment member is movable within the outer housing to adjust an angle between the first attachment projection and the second attachment projection.

11. The flexible conductive gun tube of claim 9, wherein the spring is a wave washer.

12. The flexible conductive gun tube of claim 9, wherein the spring is a wave spring.

13. The flexible conductive gun tube of claim 9, wherein one of the first attachment projection and the second attachment projection has internal threads and a different one of the first attachment projection and the second attachment projection has external threads.

14. The flexible conductive gun tube of claim 9, wherein the first attachment projection has internal threads for connecting the first attachment member to the first adjacent articulated segment, and the second attachment projection has external threads for connecting the second attachment member to the second adjacent articulated segment.

15. The flexible conductive gun tube of claim 9, wherein the annular projection is located at a terminal end of the axially-extending body.

16. A flexible conductive gun tube for a welding torch, comprising:
a plurality of articulated segments connected in series for conducting welding current from a torch handle to a torch diffuser, wherein an articulated segment of the plurality of articulated segments comprises:
an outer housing having:
an axially-extending body forming a cylindrical outer surface; and
a radially inwardly projecting rim located at a first end of the axially-extending body and defining an opening into an interior of the outer housing,
wherein the axially-extending body has an internal annular groove formed in an inner surface of the axially-extending body, and the internal annular groove is located proximate a second end of the axially-extending body opposite the first end;
a first attachment member for attachment to a first adjacent articulated segment of the plurality of articulated segments, wherein the first attachment member comprises a ball portion located within the outer housing and that extends through said opening, and a first attachment projection that extends away from ball portion and the outer housing and that has internal threads for connecting the first attachment member to the first adjacent articulated segment;
a second attachment member for attachment to a second adjacent articulated segment of the plurality of articulated segments, wherein the second attachment member comprises a socket located within the outer housing for receiving the ball portion, and a second attachment projection integrally formed with the socket and extending axially from the socket past the internal annular groove, wherein the second attachment projection has external threads for connecting the second attachment member to the second adjacent articulated segment;
a retaining ring located within the internal annular groove and radially between the second attachment projection and the internal annular groove; and
a spring located within the outer housing, radially between the second attachment projection and the axially-extending body, and axially between the retaining ring and the socket, wherein the spring biases the second attachment member toward the ball portion.

17. The flexible conductive gun tube of claim 16, wherein an axial movement of the ball portion within the outer housing is limited by the radially inwardly projecting rim.

18. The flexible conductive gun tube of claim 17, wherein the first attachment member is movable within the outer housing to adjust an angle between the first attachment projection and the second attachment projection.

19. The flexible conductive gun tube of claim 16, wherein the spring is a wave washer.

20. The flexible conductive gun tube of claim 16, wherein the spring is a wave spring.
